(19) United States
(12) Patent Application Publication
(10) Pub. No.: US 2004/0221971 A1
(43) Pub. Date: Nov. 11, 2004

(54) Sideways-opening handling door

(76) Inventor: Bernard Simon, Caluire et Cuire (FR)

Correspondence Address: YOUNG & THOMPSON, 745 SOUTH 23RD STREET 2ND FLOOR, ARLINGTON, VA, 22202

(21) Appl. No.: 10/660,627

(22) Filed: Sep. 12, 2003

(30) Foreign Application Priority Data
Sep. 13, 2002 (FR) 0211361

(51) Int. Cl. E05D 15/26

(52) U.S. Cl. 160/206

(57) ABSTRACT

The handling door for an industrial building comprising vertical uprights (2, 3) between which there slides sideways, from an open position to a closed position, via drive elements (7), a screen (4) made up of semi-rigid leaves (5) connected to one another, comprises guide elements (8) which consist of superposed and parallel horizontal tubes (17, 19) connecting the uprights (2, 3) together and of oblong and parallel openings (18, 20) formed in each of the semi-rigid leaves (5) of the screen (4) to allow the tubes to pass in a horizontal direction through the semi-rigid leaves (5) so as to guide the latter as they are moved from an open position to a closed position by drive elements (7).

The present invention relates to a handling door for an industrial building comprising a flexible screen moving sideways with respect to the fixed uprights of the door, so as to achieve open and closed positions.

The handling door comprises vertical uprights fixed in the surround of an opening made is a wall, a flexible screen which moves sideways to fold concertina-fashion and drive means for moving the flexible screen sideways.

The handling door for an industrial building according to the present invention comprises vertical uprights between which there slides sideways, from an open position to a closed position, via drive means, a screen made up of semi-rigid leaves connected to one another, and guide means which consist of superposed and parallel horizontal tubes connecting the uprights together and of oblong and parallel openings formed in each of the semi-rigid leaves of the screen to allow the said tubes to pass in a horizontal direction through the the said semi-rigid leaves so as to guide the latter as they are moved from an open position to a closed position by drive means.

The handling door for an industrial building according to the present invention comprises tubes which are connected together by deflection means allowing the second tube to pivot about the first so that each vertical leaf can deflect when the screen is subjected to an external pressure force.

The handling door for an industrial building according to the present invention comprises deflection means in which the ends of the tube pass through openings in the shape of a portion of a circle, formed in each upright so as to collaborate the connecting rod which pivots freely about the first tube.

The handling door for an industrial building according to the present invention comprises, on each semi-rigid leaf, openings the oblong profile of which is directed in a horizontal direction with respect to the tubes.

The handling door for an industrial building according to the present invention comprises an opening in the shape of a portion of a circle that is centered with respect to the tube so as to allow the leaves to deflect with the same inclination in the direction of the external pressure force on the screen.

The handling door for an industrial building according to the present invention comprises a screen which consists of two separate elements (A and B) respectively formed of semi-rigid vertical leaves connected to one another by a flexible and articulated connection.

The handling door for an industrial building according to the present invention comprises semi-rigid leaves that are connected together so that they can pivot with respect to each other from an inclined position α or β with respect to an axis XX′ perpendicular to the tubes when the screen is closed to a position δ approximately perpendicular to the tubes when the screen is open.

The handling door for an industrial building according to the present invention comprises a first element (A) comprising, in the collection of leaves of which it is made, a first end vertical leaf that allows the screen to be fixed to the vertical upright by a fastening device detachable under an external pressure force, and a second end leaf which is connected by a fixing device to the drive means.

The handling door for an industrial building according to the present invention comprises a second element comprising, in the collection of leaves of which it is made, a first end vertical leaf that allows the screen to be fixed to the vertical upright by a fastening device detachable under an external pressure force, and a second end leaf which is connected by another fixing device to the drive means.

The handling door for an industrial building according to the present invention comprises drive means that consist of a cable arranged in a loop passing through the uprights to collaborate with guide pulleys at least one of which is secured to an output shaft of a motor to run the cable in a rotational movement over the screen to drive the leaves sideways.

The handling door for an industrial building according to the present invention comprises fixing devices [lacuna] are fixed respectively to strands of the cable to drive the end leaves of the elements sideways in opposite sideways directions.

The handling door for an industrial building according to the present invention comprises drive means that are housed in the tubes of the guide means to move the semi-rigid leaves of the screen.

The handling door for an industrial building according to the present invention comprises drive means that are borne by the tubes of the guide means to move the semi-rigid leaves of the screen.

The description which will follow, with reference to the attached drawings given by way of nonlimiting examples, will allow a better understanding of the invention, of its characteristics, and of a few advantages it is likely to afford.

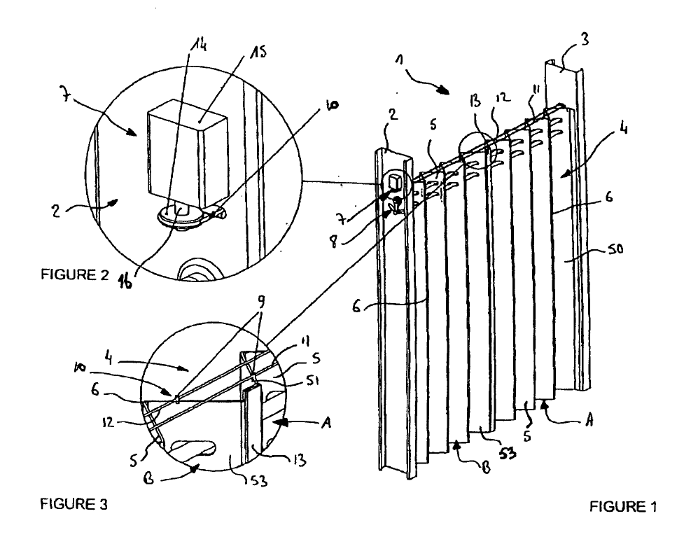

FIG. 1 is a perspective view illustrating the handling door in a closed position according to the present invention.

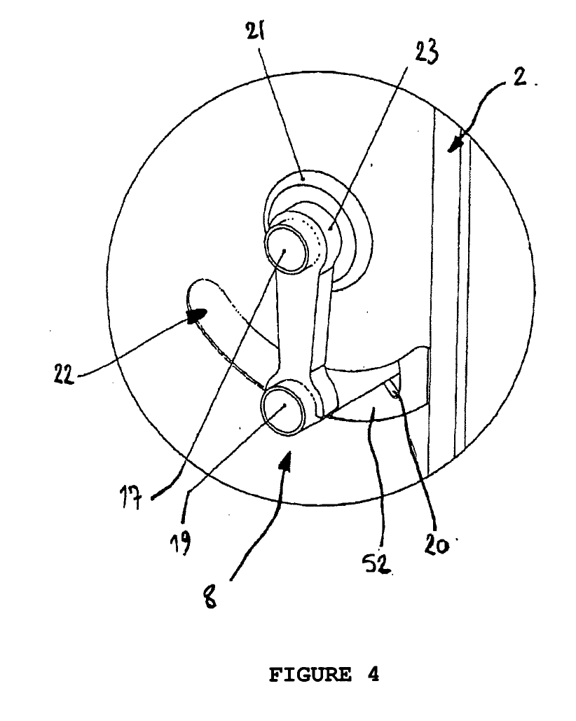

FIGS. 2 and 3 are detailed views showing the drive means for driving the flexible screen of the handling door according to the present invention.

FIG. 4 is a detailed view depicting the guide means for guiding the flexible screen of the handling door according to the present invention.

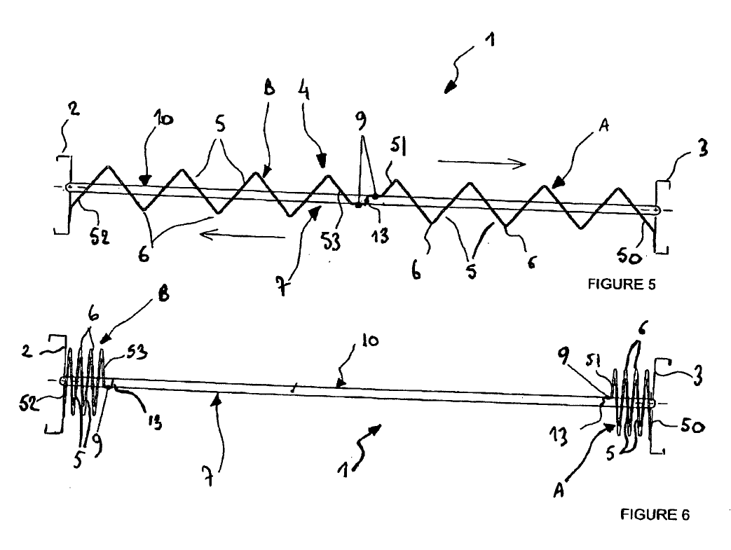

FIGS. 5 and 6 are views illustrating the routing of the flexible screen with respect to the fixed upright of the handling door according to the present invention.

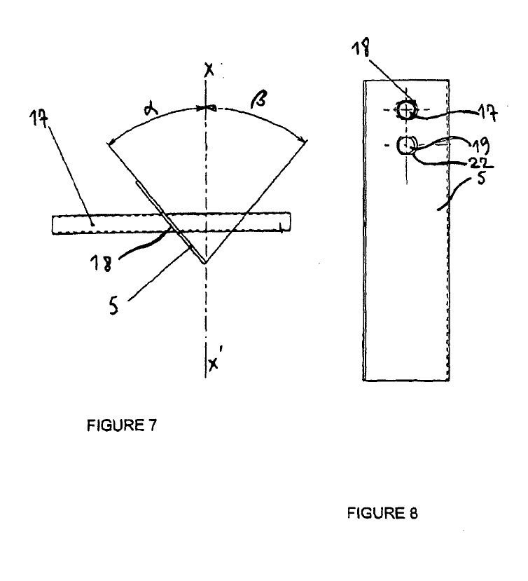

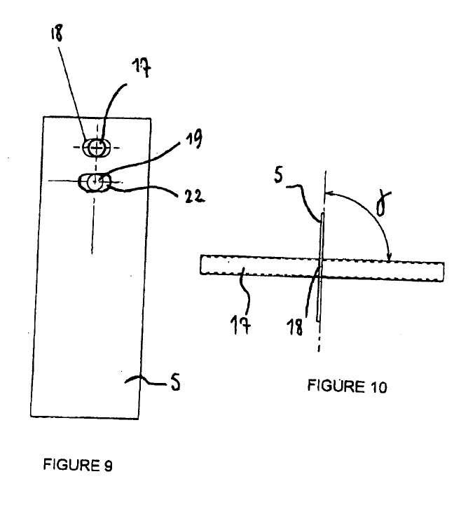

FIGS. 7 and 8 are views showing the position of the panels of the flexible screen in the closed position with respect to the guide means of the handling door of the present invention.

FIGS. 9 and 10 are views depicting the position of the panels of the flexible screen in the open position with respect to the guide means of the handling door according to the present invention.

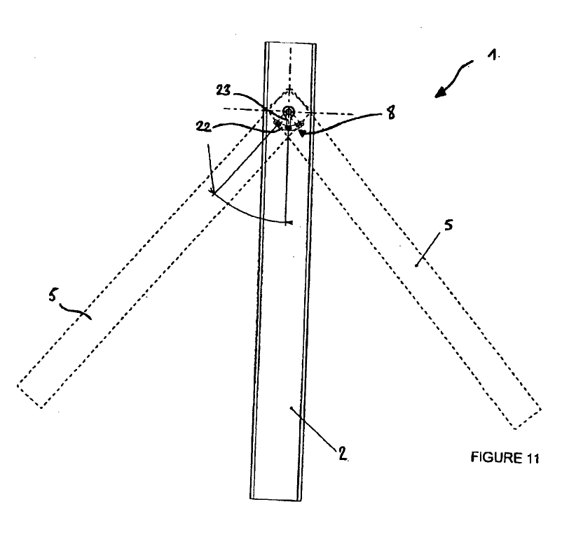

FIG. 11 is a view illustrating the positions of maximum deflection of the flexible screen with respect to the fixed uprights of the handling door according to the present invention.

FIGS. 1 to 4 show a handling door 1 comprising vertical uprights 2 and 3 which are fixed in the surround of an opening formed in a wall of an industrial building, in order to separate two distinct spaces.

The handling door 1 comprises a screen 4 consisting of two distinct elements A and B formed respectively of semi-rigid vertical leaves 5 connected together by a flexible and articulated connection 6.

The elements A and B of the screen 4 are moved sideways, from a closed position to an open position, toward the uprights 2 and 3 by drive means 7 and guide means 8.

Thus, each element A and B of the screen 4 moves, because of the way the vertical leaves 5 are positioned with respect to each other, in a concertina-folding movement between the vertical uprights 2 and 3.

The element A comprises, in the collection of leaves 5 of which it is made, a first end vertical leaf 50 that allows the screen 4 to be fixed to the vertical upright 3 by a fastening device detachable under an external pressure force.

The element A also comprises a second end leaf 51 connected by a fixing device 9 to the first strand 11 of a cable 10 in the form of a loop belonging to the drive means 7.

The other element B comprises, in the collection of leaves 5 of which it is made, a first end vertical leaf 52 that allows the screen 4 to be fixed to the vertical upright 2 by a fastening device detachable under an external pressure force.

The element B also comprises a second end leaf 53 which is connected by another fixing device 9 to the second strand 12 of the cable 10 in the form of a loop belonging to the drive means 7.

The fastening devices allowing the end leaves 50 and 52 to be fixed to the vertical uprights 2 and 3 are made up of two woven or non-woven strips, of different structure, so that they grip by touch and close contact.

The end leaves 51 and 53 of each element A and B respectively comprise a fastening device 13 of different structure or straps, to close the screen 4 when all the leaves 5 are unfolded.

The drive means 7 consist of a cable 10 arranged in a loop and passing through the uprights 2 and 3 via an opening, to collaborate with a guide pulley 14.

The cable 10 is arranged just above the upper edge of each leaf 5 of the flexible screen 4 so that the fixing devices 9, secured to the strands 11 and 12 of the said cable, are fixed to the upper edges of the end leaves 51 and 53 of the elements A and B, to drive these elements in opposite sideways directions.

The drive means 7 comprise, inside the upright 2, a motor 15 provided with an output shaft 16, on which there is fixed a pulley 14 for the rotation of the cable 10, over the flexible screen 4, so as to bring the elements A and B from a closed position into an open position (FIGS. 6 and 7).

The guide means 8 consist of a first tube 17 passing through the first oblong openings 18 made in the upper part of each vertical leaf 5 of the screen 4.

The ends of the tube 17 pass through the uprights 2 and 3 to collaborate with a connecting device 21 so that the tube constitutes a rigid and horizontal guide along which the leaves 5 of each element A and B slide during sideways movements.

The guide means 8 consist of a second tube 19, parallel to and beneath the first 17 and passing through other oblong openings 20 formed beneath the first ones 18, and in the upper part of each vertical leaf 5 of the flexible screen 4.

The ends of the tube 19 pass through the openings 22 in the shape of a portion of a circle, formed in each upright 2 and 3, to collaborate with a connecting rod 23 that pivots about the first tube 17.

Thus, the tube 19 constitutes a horizontal guide parallel to the tube 17, but also constitutes a device for the lateral deflection of the leaves 5 of each element A and B of the screen 4, when the latter experiences an external pressure force.

FIGS. 7 and 8 depict the position of the leaves 5 of each element A and B with respect to the parallel tubes 17 and 19 of the guide means and deflection means 8, when the flexible screen 4 is in the closed position.

It can be seen that each leaf 5 has an inclined position with respect to the tubes 17, 19 when the flexible screen 4 is closed. This inclination of the leaves 5 is obtained by virtue of the oblong profile of the openings 18 and 20 formed one above the other in the upper part of the said leaves.

What actually happens is that the oblong profile of the openings 18 and 20 is directed in a horizontal direction with respect to the tubes 17, 19, allowing the leaves 5 to be inclined by an angle α or β with respect to an axis XX′ perpendicular to the said tubes.

FIGS. 9 and 10 show the position of the leaves 5 of each element A and B with respect to the parallel tubes 17 and 19 of the guide means 8 when the flexible screen 4 is in the open position.

When the flexible curtain 4 is open, the leaves 5 can set themselves in a maximum position perpendicular to the tubes 17 and 19, at an angle δ.

FIG. 11 illustrates the angular deflection of the leaves 5, when the flexible screen 4 is closed and is subjected to an external pressure force in the direction of passing through the handling door 1.

What happens is that the leaves 5 have, passing through them, the tube 19 which is housed in the opening 22 in the shape of a portion of a circle which is formed in the uprights 2 and 3 and which tube is connected to the fixed tube 17 via the connecting rod 23 free to rotate about the said tube 17.

Thus, when external pressure force is applied to the leaves 5, these can deflect angularly because of the pivoting of the tube 19 about the tube 17 via the connecting rod 23 and in the opening 22 shaped as a portion of the circle.

The opening 22 shaped as a portion of a circle is centered on the tube 17 so as to allow the leaves 5 to deflect by the same inclination according to the direction of the external pressure force on the flexible screen 4.

According to a first alternative form, the drive means 7 are housed in the tubes 17, 18 of the guide means 8 to move the semi-rigid leaves 5 of the screen 4.

According to a second alternative form, the drive means 7 are borne by the tubes 17, 18 of the guide means 8 to move the semi-rigid leaves 5 of the screen 4.

It must also be understood that the foregoing description has been given merely by way of example and that it does not in any way restrict the scope of the invention, which would not be departed from if the embodiment details described were replaced by any other equivalent details.

1. Handling door for an industrial building comprising vertical uprights (2, 3) between which there slides sideways, from an open position to a closed position, via drive means (7), a screen (4) made up of semi-rigid leaves (5) connected to one another, characterized in that it comprises guide means (8) which consist of superposed and parallel horizontal tubes (17, 19) connecting the uprights (2, 3) together and of oblong and parallel openings (18, 20) formed in each of the semi-rigid leaves (5) of the screen (4) to allow the said tubes to pass in a horizontal direction through the said semi-rigid leaves (5) so as to guide the latter as they are moved from an open position to a closed position by drive means (7).

2. Handling door according to claim 1, characterized in that the tubes (17, 19) are connected together by deflection means (22, 23) allowing the second tube (19) to pivot about the first (17) so that each vertical leaf (5) can deflect when the screen (4) is subjected to an external pressure force.

3. Handling door according to claim 2, characterized in that the ends of the tube (19) pass through openings (22) in the shape of a portion of a circle, formed in each upright (2, 3) so as to collaborate the connecting rod (23) which pivots freely about the first tube (17).

4. Handling door according to claim 1, characterized in that the oblong profile of the openings (18, 20) is directed in a horizontal direction with respect to the tubes (17, 19).

5. Handling door according to claim 3, characterized in that the opening (22) in the shape of a portion of a circle is centered with respect to the tube (17) so as to allow the leaves (5) to deflect with the same inclination in the direction of the external pressure force on the screen (4).

6. Handling door according to claim 1, characterized in that the screen (4) consists of two separate elements (A and B) respectively formed of semi-rigid vertical leaves (5) connected to one another by a flexible and articulated connection (6).

7. Handling door according to claim 6, characterized in that the semi-rigid leaves (5) are connected together so that they can pivot with respect to each other from an inclined position α or β with respect to an axis XX′ perpendicular to the tubes (17, 19) when the screen (4) is closed to a position δ approximately perpendicular to the tubes (17, 19) when the screen (4) is open.

8. Handling door according to claim 6, characterized in that the element (A) comprises, in the collection of leaves (5) of which it is made, a first end vertical leaf (50) that allows the screen (4) to be fixed to the vertical upright (3) by a fastening device detachable under an external pressure force, and a second end leaf (51) which is connected by a fixing device (9) to the drive means (7).

9. Handling door according to claim 6, characterized in that the element (B) comprises, in the collection of leaves (5) of which it is made, a first end vertical leaf (52) that allows the screen (4) to be fixed to the vertical upright (2) by a fastening device detachable under an external pressure force, and a second end leaf (53) which is connected by another fixing device (9) to the drive means (7).

10. Handling door according to claim 1, characterized in that the drive means (7) consist of a cable (10) arranged in a loop passing through the uprights (2, 3) to collaborate with guide pulleys (14) at least one of which is secured to an output shaft (16) of a motor (15) to run the cable (10) in a rotational movement over the screen (4) to drive the leaves (5) sideways.

11. Handling door according to claim 10, characterized in that the fixing devices (9) are fixed respectively to strands (11, 12) of the cable (10) to drive the end leaves (51, 53) of the elements (A, B) sideways in opposite sideways directions.

12. Handling door according to claim 1, characterized in that the drive means (7) are housed in the tubes (17, 18) of the guide means (8) to move the semi-rigid leaves (5) of the screen (4).

13. Handling door according to claim 1, characterized in that the drive means (7) are borne by the tubes (17, 18) of the guide means (8) to move the semi-rigid leaves (5) of the screen (4).
